(19) United States
(12) Patent Application Publication
(10) Pub. No.: US 2026/0217349 A1
(43) Pub. Date: Jul. 30, 2026

(54) CONTROLLING BUOYANCY OF UNDERWATER DEVICE USING FUEL CELLS AND PROPELLERS

(71) Applicants: UNIVERSITY OF HOUSTON SYSTEM, Houston, TX (US); WILLIAM MARSH RICE UNIVERSITY, Houston, TX (US)

(72) Inventors: Zheng Chen, Sugar Land, TX (US); Fathi H. Ghorbel, Pearland, TX (US)

(73) Assignees: UNIVERSITY OF HOUSTON SYSTEM, Houston, TX (US); WILLIAM MARSH RICE UNIVERSITY, Houston, TX (US)

(21) Appl. No.: 19/147,340

(22) PCT Filed: Jan. 11, 2024
(86) PCT No.: PCT/US2024/011259

§ 371 Date: Jul. 11, 2025

Related U.S. Application Data
(60) Provisional application No. 63/438,483, filed on Jan. 11, 2023.

(51) Int. Cl. B63G 8/22; B63G 8/00; B63G 8/16; B63G 8/24; H01M 8/04082; H01M 8/04089; H01M 8/0438; H01M 8/04746; H01M 8/18

(52) U.S. Cl. CPC B63G 8/22; B63G 8/001; B63G 8/16; B63G 8/24; H01M 8/04104; H01M 8/04201; H01M 8/0438; H01M 8/04753; H01M 8/04761; H01M 8/184; B63G 2008/002; H01M 2250/20

(57) ABSTRACT

An underwater device with buoyancy control as well as a method and computer program product for buoyancy control of an underwater device. Upon receiving an estimate of a current depth of the underwater device, a calculation is performed to determine the difference between the estimated current depth of the underwater device and the target. Based on such a difference exceeding a threshold value, an input to fuel cells in the underwater device is generated to either produce a net gas rate which is accumulated by flexible membranes to gain a volume which generates a positive buoyancy force or to intake gasses which generates a negative buoyancy force. The positive buoyancy force and the negative buoyancy force are used to control the depth of the underwater device to reach a target depth from the current depth.

### CROSS REFERENCE TO RELATED APPLICATIONS

This application claims priority to U.S. Provisional Patent Application Ser. No. 63/438,483 entitled “Variable Buoyancy Control Using Reversible Fuel Cell,” filed on Jan. 11, 2023, which is incorporated by reference herein in its entirety.

### TECHNICAL FIELD

The present disclosure relates generally to autonomous underwater vehicles, and more particularly to controlling the buoyancy of underwater devices, such as autonomous underwater vehicles, using both soft actuators, such as reversible fuel cells, and hard actuators, such as propellers.

### BACKGROUND

An autonomous underwater vehicle (AUV) is a robot that travels underwater without requiring continuous input from an operator. AUVs constitute part of a larger group of undersea systems known as unmanned underwater vehicles, a classification that includes non-autonomous remotely operated underwater vehicles (ROVs)—controlled and powered from the surface by an operator/pilot via an umbilical or using remote control. In military applications, an AUV is more often referred to as an unmanned undersea vehicle (UUV). Underwater gliders are a subclass of AUVs.

Currently, AUVs are calibrated for buoyancy before service. Buoyancy, or upthrust, is an upward force exerted by a fluid that opposes the weight of a partially or fully immersed object, such as an autonomous underwater vehicle. In a column of fluid, pressure increases with depth as a result of the weight of the overlying fluid. Thus, the pressure at the bottom of a column of fluid is greater than at the top of the column. Similarly, the pressure at the bottom of an object submerged in a fluid is greater than at the top of the object. The pressure difference results in a net upward force on the object. The magnitude of the force is proportional to the pressure difference, and (as explained by Archimedes' principle) is equivalent to the weight of the fluid that would otherwise occupy the submerged volume of the object, i.e., the displaced fluid.

For this reason, an object whose average density is less than that of the fluid in which it is submerged tends to sink. If the object is less dense than the liquid, the force can keep the object afloat. This can occur only in a non-inertial reference frame, which either has a gravitational field or is accelerating due to a force other than gravity defining a “downward” direction.

After calibrating the AUV for buoyancy, a minimal change in buoyancy is often required. As a result, AUVs may rely on “thrusters” and possibly a ballast to actively control buoyancy. A thruster refers to a propulsive device used for low-thrust acceleration. If, however, AUVs are involved in forceful interactions, including lifting objects or executing a forceful act, thrusters and a ballast may not be fully adequate for real-time buoyancy control.

### SUMMARY

In one embodiment of the present disclosure, a method for buoyancy control of an underwater device comprises receiving an estimate of a current depth of the underwater device. The method further comprises generating an input to fuel cells in the underwater device to produce a net gas rate which is accumulated by flexible membranes to gain a volume which generates a positive buoyancy force or generating an input to the fuel cells in the underwater device to intake gasses which generates a negative buoyancy force, where the positive buoyancy force and the negative buoyancy force are used to control a depth of the underwater device to reach a target depth from the current depth.

Another form of the embodiment of the method described above is in a computer program product.

In another embodiment of the present disclosure, an underwater device comprises a control system for controlling the depth of the underwater device using the method discussed above for buoyancy control.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of an underwater device;

FIG. 2 illustrates the components of the control system in accordance with an embodiment of the present disclosure;

FIG. 3 illustrates the schematic and free body diagram of the underwater device which includes both a soft actuator and a hard actuator in accordance with an embodiment of the present disclosure;

FIGS. 4A-4B illustrate a prototype of the underwater device in accordance with an embodiment of the present disclosure;

FIG. 5 is a control diagram illustrating the control of the underwater device by the control system in accordance with an embodiment of the present disclosure;

FIG. 6 illustrates the response profile of the simulation in accordance with an embodiment of the present disclosure;

FIG. 7 illustrates the applied voltage on DC motors when the fuel cells are not working in accordance with an embodiment of the present disclosure;

FIG. 8 illustrates the applied voltage on DC motors when the fuel cells are working in accordance with an embodiment of the present disclosure;

FIG. 9 illustrates the applied voltage on the fuel cells in accordance with an embodiment of the present disclosure;

FIG. 10 illustrates an embodiment of the present disclosure of the hardware configuration of the control system; and

FIG. 11 is a flowchart of a method for buoyancy control of an underwater device in accordance with an embodiment of the present disclosure.

### DETAILED DESCRIPTION

As stated above, an autonomous underwater vehicle (AUV) is a robot that travels underwater without requiring continuous input from an operator. AUVs constitute part of a larger group of undersea systems known as unmanned underwater vehicles, a classification that includes non-autonomous remotely operated underwater vehicles (ROVs)—controlled and powered from the surface by an operator/pilot via an umbilical or using remote control. In military applications, an AUV is more often referred to as an unmanned undersea vehicle (UUV). Underwater gliders are a subclass of AUVs.

Currently, AUVs are calibrated for buoyancy before service. Buoyancy, or upthrust, is an upward force exerted by a fluid that opposes the weight of a partially or fully immersed object, such as an autonomous underwater vehicle. In a column of fluid, pressure increases with depth as a result of the weight of the overlying fluid. Thus, the pressure at the bottom of a column of fluid is greater than at the top of the column. Similarly, the pressure at the bottom of an object submerged in a fluid is greater than at the top of the object. The pressure difference results in a net upward force on the object. The magnitude of the force is proportional to the pressure difference, and (as explained by Archimedes' principle) is equivalent to the weight of the fluid that would otherwise occupy the submerged volume of the object, i.e., the displaced fluid.

For this reason, an object whose average density is less than that of the fluid in which it is submerged tends to sink. If the object is less dense than the liquid, the force can keep the object afloat. This can occur only in a non-inertial reference frame, which either has a gravitational field or is accelerating due to a force other than gravity defining a “downward” direction.

After calibrating the AUV for buoyancy, a minimal change in buoyancy is often required. As a result, AUVs may rely on “thrusters” and possibly a ballast to actively control buoyancy. A thruster refers to a propulsive device used for low-thrust acceleration. If, however, AUVs are involved in forceful interactions, including lifting objects or executing a forceful act, thrusters and a ballast may not be fully adequate for real-time buoyancy control.

The embodiments of the present disclosure provide a means for buoyancy control of an underwater device, such as autonomous underwater vehicle, by utilizing fuel cells (e.g., reversible fuel cells) to produce a net gas rate which is accumulated by flexible membranes to gain a volume which generates a positive buoyancy force or to intake gasses which generates a negative buoyancy force. The buoyancy force is used to control the underwater device to reach a target depth from a current depth, which is estimated from a sensor (e.g., pressure sensor). Since the rate of the change of buoyancy is small due to the slow process of fuel cells, in one embodiment, in addition to utilizing a soft actuator, such as reversible fuel cells, for buoyancy control, a hard actuator, such as propellers, may also be used for buoyancy control. In such an embodiment, the difference between the estimated current depth and the target depth is determined. In response to the difference between the estimated current depth and the target depth exceeding a positive threshold value, an input to the fuel cells (e.g., reversible fuel cells) is generated, which enables the fuel cells to produce the net gas rate which is accumulated by the flexible membranes to gain the volume which generates a positive buoyancy force. By implementing a positive buoyancy, the underwater device will be lifted upwards towards the target depth. Furthermore, in response to the difference between the estimated current depth and the target depth exceeding the positive threshold value, an input to one or more motors is generated, which enables the motor(s) to generate a positive thrust force based on the difference between the estimated current depth and the target depth, which is used to lift upwards the underwater device towards the target depth. In one embodiment, the thrust force is used to control the hard actuators, such as propellers, which controls the depth of the underwater device. The positive buoyancy force and the positive thrust force are combined to form a net force which controls a vertical dynamic motion (e.g., lifts the underwater device upwards towards the target depth) of the underwater device. In an alternative mode of operation, in response to the difference between the estimated current depth and the target depth exceeding a negative threshold value, an input to the fuel cells (e.g., reversible fuel cells) is generated to intake gasses and convert them to water thereby generating a negative buoyancy force. By implementing a negative buoyancy, the underwater device will be lowered towards the target depth. Furthermore, in response to the difference between the estimated current depth and the target depth exceeding the negative threshold value, an input to one or more motors is generated, which enables the motor(s) to generate a negative thrust force based on the difference between the estimated current depth and the target depth, which is used to lower the underwater device towards the target depth. The negative buoyancy force and the negative thrust force are combined to form a net force which controls a vertical dynamic motion (e.g., lowering the underwater device to the target depth) of the underwater device. By utilizing both a soft actuator and a hard actuator, an effective approach for buoyancy control of an underwater device is achieved. These and other features will be discussed in further detail below.

In one embodiment, the fuel cells discussed above correspond to polymer electrolyte membrane (PEM) fuel cells, which use a proton-conducting polymer membrane as the electrolyte. In one embodiment, hydrogen is used as the fuel in which these fuel cells operate at relatively low temperatures and can quickly vary their output to meet shifting power demands. In one embodiment, the fuel cells are connected to flexible membranes and provide hydrogen and oxygen gases to the inside of the flexible membranes when it is necessary to increase the buoyancy of the underwater device (e.g., AUV). Inversely, it is also able to take gases back and convert them to water when there is a need to become negative buoyant. As a result, the underwater device becomes able to keep its depth by adjusting its buoyancy, which helps to save a lot of energy and to have a perfectly smooth response.

Since the rate of the change of buoyancy is small due to the slow process of fuel cells, in one embodiment, both hard actuators (e.g., propellers connected to motors) and soft actuators (e.g., fuel cells) are used to control the depth of the underwater device. As a result, at the beginning of the process, propellers dominate the movements of the underwater device by applying larger forces and will be able to keep the underwater device at a desired level for a short duration of time until the reversible fuel cells are able to keep the depth by itself. As a result, the use of fuel cells are utilized while addressing the slow response of the fuel cells.

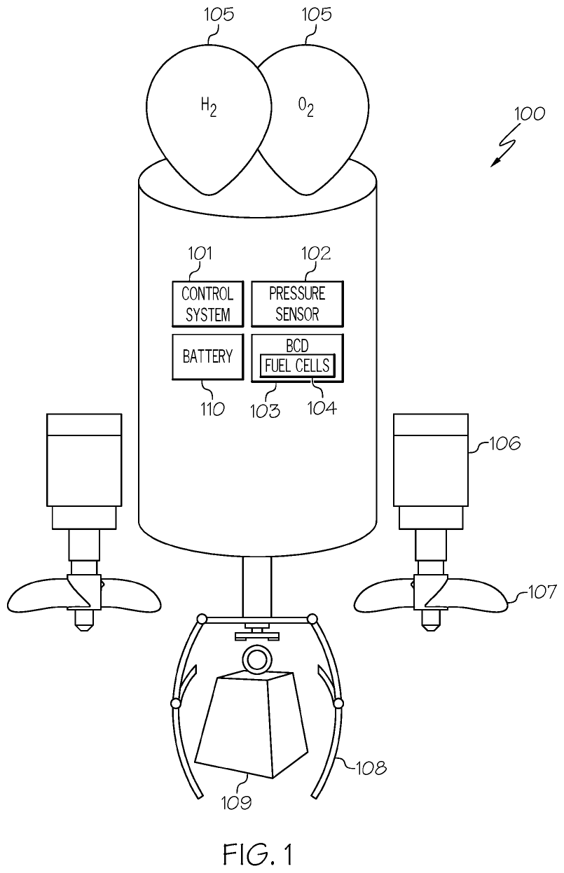

Referring now to the Figures in detail, FIG. 1 illustrates an underwater device 100 (e.g., AUV) in accordance with an embodiment of the present disclosure.

As shown in FIG. 1, underwater device 100 includes a control system 101 for controlling the buoyancy of underwater device 100 as discussed herein.

Underwater device 100 further includes a pressure sensor 102 configured to estimate a current depth of underwater device 100. Pressure sensor 102 may correspond to a CTD (conductivity, temperature, depth) sensor, such as, but not limited to, RBRlegato³, SBE 49 FastCAT, etc.

Underwater device 100 additionally includes a buoyancy control device (BCD) 103 that includes fuel cells 104, such as reversible fuel cells. A reversible full cell, as used herein, refers to a fuel cell running in reverse mode, in which it consumes electricity and chemical B to produce chemical A. An example of such a fuel cell is the reversible proton exchange membrane (PEM) fuel cell, which uses a proton-conducting polymer membrane as the electrolyte.

In one embodiment, control system 101 is configured to instruct fuel cells 104 of BCD 103 to provide gases, such as the hydrogen and oxygen gases to the inside of flexible membranes, such as balloons 105, when it is necessary to increase the buoyancy of underwater device 101. A membrane, as used herein, refers to a thin pliable sheet of material forming a barrier or lining. While the following discusses the present disclosure in connection with utilizing balloons, such as balloons 105, to store gases, such as hydrogen and oxygen, the principles of the present disclosure may utilize any flexible or elastic material, including a thin pliable sheet of material forming a barrier or lining, with any shape (spherical or not) that increases volume due to the production of oxygen and hydrogen gases inside that shape. A person of ordinary skill in the art would be capable of applying the principles of the present disclosure to such implementations. Furthermore, embodiments applying the principles of the present disclosure to such implementations would fall within the scope of the present disclosure.

Conversely, control system 101 is configured to instruct fuel cells 104 of BCD 103 to intake gasses, such as the hydrogen and oxygen gases inside the flexible membranes (e.g., balloons 105) and convert them to water when there is a need to become negative buoyant. In one embodiment, control system 101 instructs fuel cells 104 to operate in one of these modes based on the input (e.g., voltage input) applied to fuel cells 104. That is, in one embodiment, control system 101 is configured to adapt the buoyancy of underwater device 100 to its neutral buoyant state by controlling fuel cells 104 in BCD 103. As a result, underwater device 100 becomes able to keep its depth by adjusting its buoyancy, which helps to save a lot of energy and to have a perfectly smooth response.

Furthermore, in one embodiment, underwater device 100 includes a hard actuator, such as one or more motors 106 connected to one or more propellers 107. In one embodiment, motor 106 is a direct current (DC) motor configured to generate a thrust force, which is used to control propellers 107, which controls the depth of underwater device 100. In one embodiment, control system 101 generates an input, such as a voltage input, to motor 106, which determines the speed of motor 106, which determines the amount of thrust force to be generated by motor 106, which determines the amount of spin of propeller 107, which has an affect on the depth of underwater device 100. Examples of motor 106 include, but are not limited to, ElectroCraft® RapidPower™ Xtreme brushless DC servo motor, Maxon® ECX brushless DC motor, etc. Examples of propeller 107 include, but are not limited to, Sharrow MX™ propeller, Evinrude® Hydrus™ propeller, etc.

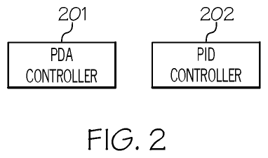

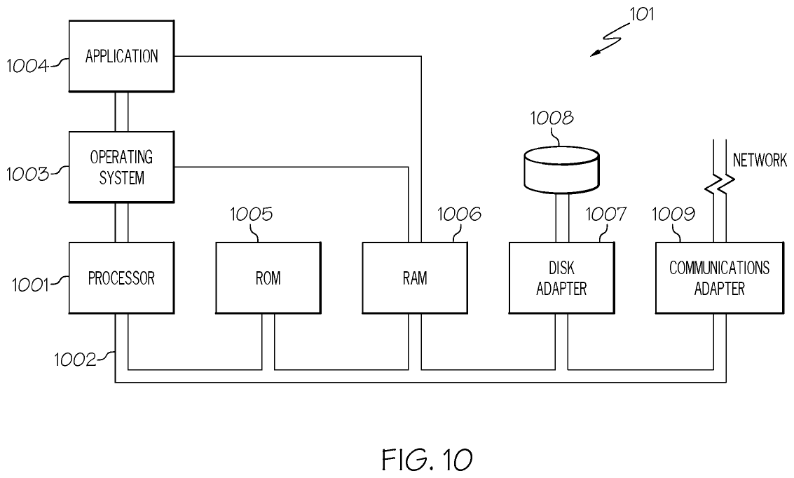

In one embodiment, by utilizing both a soft actuator (e.g., fuel cells 104) and a hard actuator (e.g., motor 106 with propeller 107), the buoyancy disturbance, depth control, and vertical maneuvering are able to be balanced by control system 101. A further description of the components of control system 101 is provided below in connection with FIG. 2. A description of the hardware configuration of control system 101 is provided further below in connection with FIG. 10.

Furthermore, as illustrated in FIG. 1, underwater device 100 includes a grabber 108, such as a robotic manipulator, which can handle tools 109 (e.g., 0.1 kg tools in the underwater environment. That is, grabber 108 is configured to pick up a tool, move the tool, and drop the tool. Examples of grabber 108 include, but are not limited to, Reach Alpha grabber by Reach Robotics®, Reach Bravo grabber by Reach Robotics®, etc. In one embodiment, grabber 108 is a water-proof robotic gripper.

Additionally, as shown in FIG. 1, the power source of underwater device 100 may be a battery 110, such as a Li-ion battery (e.g., Saft® Li-ion battery, such as Ion-OnBoard® Regen).

As discussed above, FIG. 2 illustrates the components of control system 101 in accordance with an embodiment of the present disclosure.

Referring to FIG. 2, in conjunction with FIG. 1, control system 101 includes a PDA (proportional-derivative-acceleration) controller 201 configured to regulate the generation and consumption of gases and stabilize underwater device 100 at a certain depth.

In one embodiment, PDA controller 201 generates a voltage applied to BCD 103 which produces a net gas rate.

Control system 101 further includes a PID (proportional-integral-derivative) controller 202 for regulating the output of the process. In one embodiment, PID controller 202 uses feedback from sensors to adjust the output of the system based on three main parameters: proportional control, integral control, and derivative control. The proportional control adjusts the output relative to the error, the integral control adjusts the output based on the cumulative error over time, and the derivative control adjusts the output to account for changes in the error over time. The combination of these three controls helps PID controller 202 maintain a stable and accurate output for the system.

In one embodiment, PID controller 202 generates the actuation voltage applied to propellers 107 which produce a vertical thrust force. That is, PID controller 202 is used for controlling propellers 107.

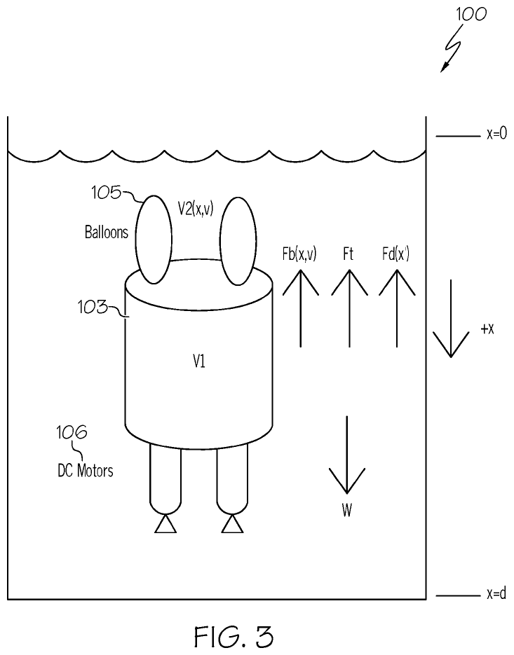

Referring now to FIG. 3, FIG. 3 illustrates the schematic and free body diagram of underwater device 100 which includes both a soft actuator (e.g., fuel cells 104 in BCM 103) and a hard actuator (e.g., motors 106 attached to propellers 107) in accordance with an embodiment of the present disclosure. In one embodiment, propellers 107 are located at the bottom of underwater device 100, and fuel cells 104 are located at the top of propellers 107. In one embodiment, underwater device 100 has one constant and one variable volume, which are V1 and V2, respectively. The displacement is represented as “x,” which is increasing from the surface to the bottom of underwater device 100. Only positive force is the weight of underwater device 100, and the negative forces are drag force (Fd), thrust force of propellers (Ft), and buoyancy force (Fb). Drag force is directly proportional to the square of the speed of underwater device 100, and buoyancy force is dependent on both the position of underwater device 100 and variable volume. In summary, the net force can be illustrated as follows:

$${F}_{net} = W - {F}_{b} ( x , {V}_{2} ( t ) ) - {F}_{t} - {F}_{d} ( \dot{x} ) , \qquad ( 1 )$$

The four forces acting on the object are:

$$Fb ( t ) = ρ ( V , + {V}_{2} ( t ) ) g , \qquad ( 2 )$$

$$d ( t ) = b {\dot{x}}^{2} ( t ) , \qquad ( 3 )$$

$$W = mg , \qquad ( 4 )$$

$$Ft = τ , \qquad ( 5 )$$

where ρ is the fluids density inside of the water, g is the gravitational constant, b is the drag coefficient, m is the total mass of the device, and k represents the force applied by propellers (e.g., propellers 107). This parameter can be considered as the control input of the system.

In one embodiment, by considering equations from Equation 2 to Equation 5, the state space representation of the system can be expressed as follows:

$$[ \begin{matrix}{\dot{X}}_{1} \\ {X}_{2}\end{matrix} ] = [ \begin{matrix}0 & 1 \\ 0 & -\end{matrix} ] [ \begin{matrix}{X}_{1} \\ {X}_{2}\end{matrix} ] + [ \begin{matrix}0 \\ - τ - \frac{ρτ}{m} {V}_{2} + g - \frac{ρτ}{m} {V}_{1}\end{matrix} ] \qquad ( 6 )$$

The second term on the right-hand side of Equation 6 includes two control parameters, which are V₂ and τ. Those can be used as control parameters of underwater device 100. A discussion regarding adjusting such control parameters is provided further below.

Alternatively, in one embodiment, Newton's second law (sum of all forces, Equation 2 to Equation 5, is equal to mass times acceleration) may be utilized instead of Equation 6.

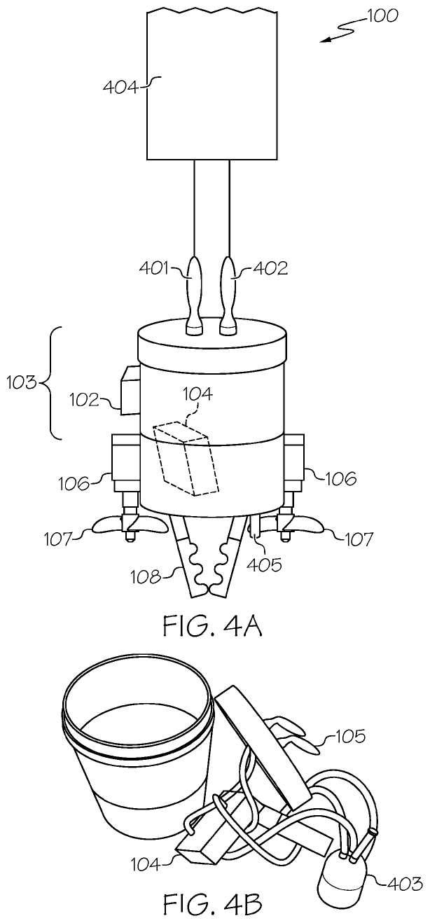

Referring now to FIGS. 4A-4B, FIGS. 4A-4B illustrate a prototype of underwater device 100 in accordance with an embodiment of the present disclosure. FIG. 4A illustrates a vertical view of underwater device 100; whereas, FIG. 4B illustrates a cross-section of the inside of the water-proof chamber BCD 103.

Such a prototype includes propellers 107 and BCD 103 (water-proof chamber) for depth control. As it can be observed from FIGS. 4A-4B, underwater device 100 is composed of two DC motors 106, two PEM fuel cells 104 with two flexible membranes, such as balloons 105 (e.g., H₂ balloon 401 and O₂ balloon 402), and one water tank 403 connected to them, one pressure sensor 102, one gripper 108, and buoyancy foams 404. In one embodiment, underwater device 100 may include some extra weights 405 to assist with buoyancy control.

In one embodiment, pressure sensor 102 is used to measure the depth underwater. In one embodiment, foams 404 are used as positive buoyant material, and extra weights 405 are used as negative buoyant material and to keep the device vertical.

In one embodiment, when fuel cells 104 are in the water electrolysis mode, they generate hydrogen and oxygen gases that flow inside two flexible membranes separately, such as balloons 401, 402, separately. Therefore, the volume of the gas inside the flexible membranes (e.g., balloons 401, 402) is increased, and the buoyancy force gets higher. Inversely, when fuel cells 104 are in fuel cell mode, the gases are consumed to generate electricity and water. As a result, there is a decrease in buoyancy force. Both of these two modes are being used in an optimal way to improve the depth control of underwater device 100. In one embodiment, the inside of water tank 403 is filled with water all the time to prevent any increase of resistance and heating up due to the hydrogen ions.

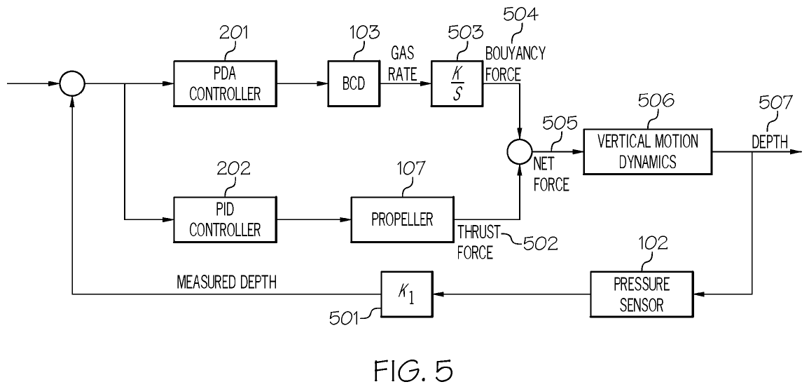

FIG. 5 is a control diagram illustrating the control of underwater device 100 by control system 101 in accordance with an embodiment of the present disclosure.

Referring now to FIG. 5, in conjunction with FIGS. 2-4B, in one embodiment, control system 101 consists of two controls by PDA controller 201 and PID controller 202, namely, the control of motors 106, propellers 107 and the control of BCD 103, respectively.

As illustrated in FIG. 5, the depth 501 (k₁) is measured by the onboard pressure sensor 102. The depth error e (difference between the estimated current depth of underwater device 100 obtained from pressure sensor 102 and a target depth, which may be user-designated) is fed to PID controller 202 to generate the actuation voltage applied to propellers 107 which produce a vertical thrust force 502. e is also fed to PDA controller 201 to generate a voltage applied to BCD 103 which produces a net gas rate 503 (K/S). Net gas rate 503 is then accumulated by the flexible membranes (e.g., balloons 105) to gain a volume which generate a buoyancy force 504. The net force 505 (combination of thrust force 502 and buoyancy force 504) controls the vertical dynamic motion 506 of underwater device 100.

The following discusses the control of propellers 107 and BCD 103, respectively.

With respect to the control of propellers 107, the capacity of thrust force 502 applied by running propellers 107 can be changed faster than buoyancy force 504 applied by fuel cells 104. It can apply forces that are enough to carry and push underwater device 100 to upper depths in just a few seconds. Therefore, in one embodiment, the control of propellers 107 is used in the control of underwater device 100.

In one embodiment, PID controller 202 is used for controlling propellers 107. The current depth 501 of underwater device 100 which comes from pressure sensor 102 will be the input of the control loop, and the difference between this value and the target depth is the error, e. The output of the control loop is voltage input to motors 106, which is directly proportional to the speed of motors 106, and the speed of motors 106 is directly proportional to thrust force 502. PID controller 202 can be expressed as follows:

$$τ ( t ) = {K}_{p} e ( t ) + {K}_{d} {e}^{′} ( t ) + {K}_{i} \int e ( t ) dt \qquad ( 7 )$$

The parameters Kp, Kd and Ki are determined based on auto tuning of a simulated model as discussed further below.

With respect to the control of BCD 103, changes in the voltage supply of fuel cells 104 may not be able to provide sudden movements because its gas generation rate is low and the change of depth is an effort of time when fuel cells 104 are used without motors 106. As a result, in one embodiment, propellers 107 are utilized to keep underwater device 100 at a desired level without waiting too long. The needed control structure for fuel cells 104 is working with maximum power when the difference between current depth 501 and a desired depth 507 is significant, i.e., working with maximum power until underwater device 100 becomes naturally buoyant.

After the error becomes less than a threshold, PDA controller 201 initiates control of BCD 103. In one embodiment, PDA controller 201 is utilized to implement acceleration control in addition to PD (proportional-derivative) control since BCD 103 is a third order system with a slow response time.

In one embodiment, when fuel cells 104 operate in water electrolysis mode and achieve natural buoyancy, fuel cells 104 may continue to operation in water electrolysis mode (do not switch to the reversible fuel cell mode) because after underwater device 100 becomes naturally buoyant, fuel cells 104 need to prevent motors 106 from running for longer periods of time. When underwater device 100 becomes naturally buoyant after a while, it is easy for motors 106 to take underwater device 100 to different desired depths by running for a very small amount of time.

In one embodiment, “ε” is designated as the error boundary (the error is assumed as significant above that point and insignificant under that point), “e” is designated as the error, and Vᵢₙₚᵤₜ is designated as the voltage input to fuel cells 104. The equation of PDA controller 201 may then be expressed as shown in Table I. where Vₘₐₓ represents the voltage which can run fuel cells 104 with maximum power.

TABLE I

| Conditions | e > ε | e < ε |
|---|---|---|
| e > 0 | Vₘₐₓ | ${K}_{p} e + {K}_{d} \text{?} + K \text{?} \text{?}$ |
| e < 0 | ${K}_{p} e + {K}_{d} \text{?} + K \text{?} \text{?}$ | 0 |

$\text{?} \text{indicates text missing or illegible when filed}$

The values of coefficients are −1.5×10⁻⁷ for Kₚ, −2.6×10⁻⁶ for K_{d}, and −1.1×10⁻⁵ for Kₐ.

A discussion regarding the parameter validation and simulations is now deemed appropriate.

By measuring the weight of underwater device 100 of FIGS. 4A-4B when it is naturally buoyant, and using the Newton's Law, the volume of underwater device 100 (V₁) is 1.204·10⁻³m³, which is the total volume of underwater device 100 when fuel cells 104 are not triggered.

In order to find the increasing velocity of V₂, another experiment was performed by increasing the weight and finding the natural buoyant point after fuel cells 104 run for a while. According to the result, the increasing rate of the volume due to fuel cells 104 (V₂) is 1.364·10⁻⁷ m³/s.

By doing further experiments, it has been observed that one propeller (e.g., propeller 107) is enough to carry 77.4 grams of weight when the applied voltage is 2.5 V, and when the buoyancy force is very negligible. In terms of applied force, it corresponds to:

$$Ft = 0.0 \; 774 kg \cdot 9.81 m / {s}^{2} = 0.76 N .$$

The other observation is that the dead zone of DC motors (e.g., motors 106) is between 0-0.5V. When it is assumed that the voltage-force relation is linear which starts at 0.5 V, and when the applied voltage is Vₐₚₚ, the net equation for the applied force becomes:

$$Ft = ( {V}_{app} - 0.5 V ) \cdot ( 0.76 N ) / 2 \cdot 2 = ( {V}_{app} - 0.5 V ) \times 0.76 N \qquad ( 8 )$$

It is noted that the reason for multiplication with 2 is that there are two propellers (e.g., propellers 107) connected to underwater device 100.

In one embodiment, a simulation was performed by considering these assumptions and results. Such a simulation was performed in order to identify the optimized values for PID controller 202 of propellers 107 by performing auto-tuning in order to have optimized control for propellers 107. A summary of the assumptions that were made for the sake of simplicity for the simulations is provided below: (1) increasing the rate of the volume of the flexible membranes (e.g., balloons 105) connected to fuel cells (e.g., fuel cells 104) is constant; (2) the relationship of applied voltage (applied force of propellers 107) is linear; and (3) the drag force of the system is negligible.

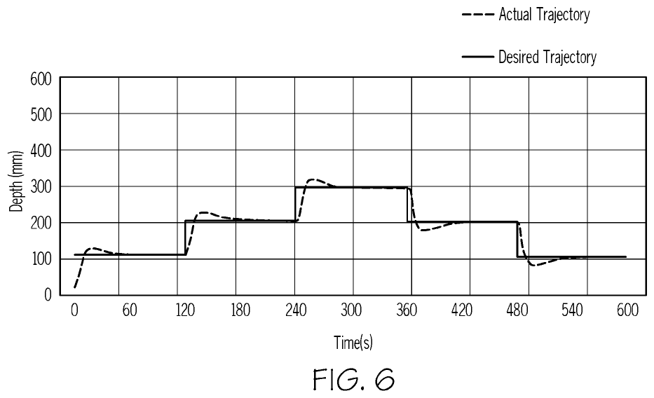

According to the results of auto-tuning (e.g., using the auto-tuning feature of Matlab® Simulink), the optimized values for “P”, “I”, and “D” gains and the filter coefficient (“N”) are 0.647, 0.0312, 3.199, and 2.123, respectively. The simulated response profile is shown in FIG. 6.

Referring to FIG. 6, FIG. 6 illustrates the response profile of the simulation in accordance with an embodiment of the present disclosure.

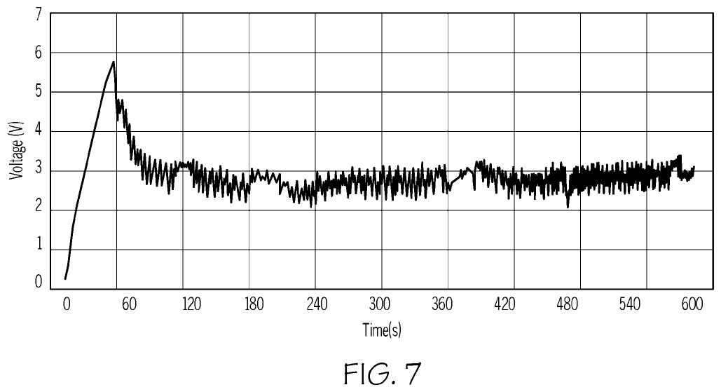

The input signals to the motor (e.g., DC motor), such as motor 106, and fuel cells 104 (e.g., PEM fuel cells 104) in the real-time experiment are provided in FIGS. 7, 8, and 9.

FIG. 7 illustrates the applied voltage on DC motors (e.g., motors 106) when the fuel cells (e.g. fuel cells 104) are not working in accordance with an embodiment of the present disclosure.

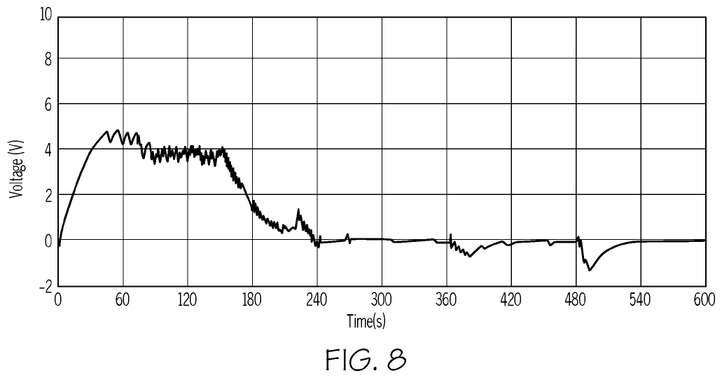

FIG. 8 illustrates the applied voltage on DC motors (e.g., motors 106) when the fuel cells (e.g. fuel cells 104) are working in accordance with an embodiment of the present disclosure.

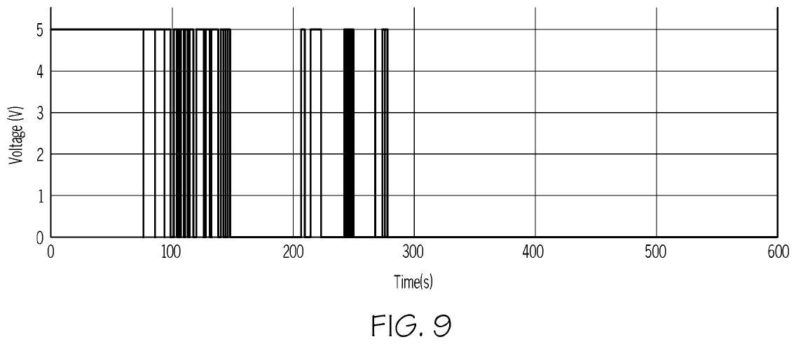

FIG. 9 illustrates the applied voltage on the fuel cells in accordance with an embodiment of the present disclosure.

A further description of these and other features is provided below in connection with the discussion of the method for buoyancy control of an underwater device.

Prior to the discussion of the method for buoyancy control of an underwater device, a description of the hardware configuration of control system 101 is provided below in connection with FIG. 10.

Referring now to FIG. 10, FIG. 10 illustrates an embodiment of the present disclosure of the hardware configuration of control system 101 (FIG. 1).

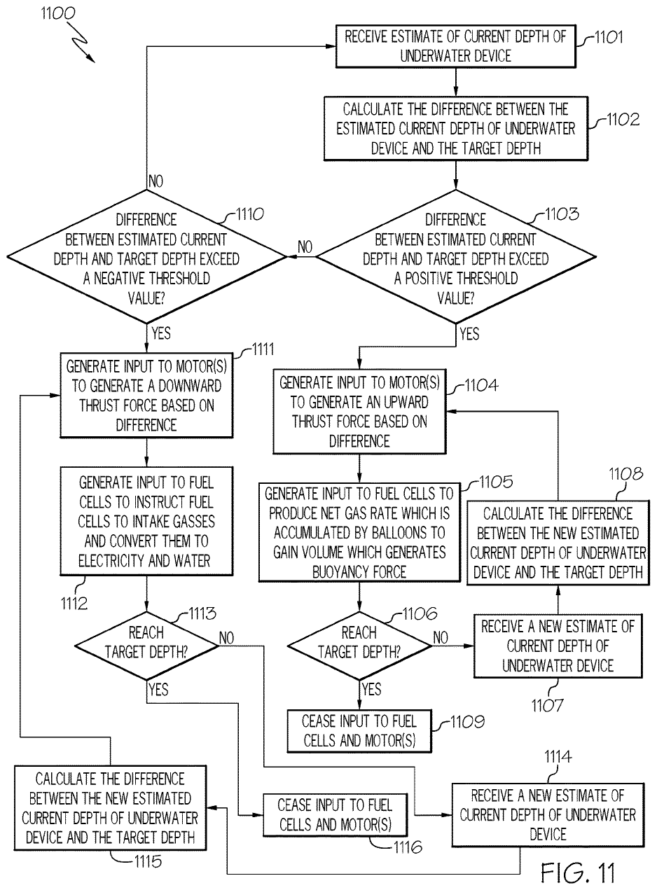

Control system 101 has a processor 1001 connected to various other components by system bus 1002. An operating system 1003 runs on processor 1001 and provides control and coordinates the functions of the various components of FIG. 10. An application 1004 in accordance with the principles of the present disclosure runs in conjunction with operating system 1003 and provides calls to operating system 1003 where the calls implement the various functions or services to be performed by application 1004. Application 1004 may include, for example, a program for buoyancy control of underwater device 100 (FIGS. 1, 3, 4A-4B and 5-9) as discussed further below in connection with FIG. 11.

Referring again to FIG. 10, read-only memory (“ROM”) 1005 is connected to system bus 1002 and includes a basic input/output system (“BIOS”) that controls certain basic functions of control system 101. Random access memory (“RAM”) 1006 and disk adapter 1007 are also connected to system bus 1002. It should be noted that software components including operating system 1003 and application 1004 may be loaded into RAM 1006, which may be control system's 101 main memory for execution. Disk adapter 1007 may be an integrated drive electronics (“IDE”) adapter that communicates with a disk unit 1008, e.g., disk drive. It is noted that the program for buoyancy control of underwater device 100 (FIGS. 1, 3, 4A-4B and 5-9), as discussed further below in connection with FIG. 11, may reside in disk unit 1008 or in application 1004.

Control system 101 may further include a communications adapter 1009 connected to bus 1002. Communications adapter 1009 interconnects bus 1002 with an outside network to communicate with other devices.

In one embodiment, application 1004 of control system 101 includes the software components (e.g., PDA controller 201, PID controller 202) for implementing buoyancy control of underwater device 100 as discussed herein. In one embodiment, such components may be implemented in hardware, where such hardware components would be connected to bus 1002. The functions discussed above performed by such components are not generic computer functions. As a result, control system 101 is a particular machine that is the result of implementing specific, non-generic computer functions.

In one embodiment, the functionality of such software components of control system 101, including the functionality for implementing buoyancy control of underwater device 100, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, currently, AUVs are calibrated for buoyancy before service. Buoyancy, or upthrust, is an upward force exerted by a fluid that opposes the weight of a partially or fully immersed object, such as an autonomous underwater vehicle. In a column of fluid, pressure increases with depth as a result of the weight of the overlying fluid. Thus, the pressure at the bottom of a column of fluid is greater than at the top of the column. Similarly, the pressure at the bottom of an object submerged in a fluid is greater than at the top of the object. The pressure difference results in a net upward force on the object. The magnitude of the force is proportional to the pressure difference, and (as explained by Archimedes' principle) is equivalent to the weight of the fluid that would otherwise occupy the submerged volume of the object, i.e., the displaced fluid. For this reason, an object whose average density is less than that of the fluid in which it is submerged tends to sink. If the object is less dense than the liquid, the force can keep the object afloat. This can occur only in a non-inertial reference frame, which either has a gravitational field or is accelerating due to a force other than gravity defining a “downward” direction. After calibrating the AUV for buoyancy, a minimal change in buoyancy is often required. As a result, AUVs may rely on “thrusters” and possibly a ballast to actively control buoyancy. A thruster refers to a propulsive device used for low-thrust acceleration. If, however, AUVs are involved in forceful interactions, including lifting objects or executing a forceful act, thrusters and a ballast may not be fully adequate for real-time buoyancy control.

The embodiments of the present disclosure provide a means for buoyancy control of an underwater device, such as an autonomous underwater vehicle, by utilizing fuel cells to produce a net gas rate which is accumulated by the flexible membranes (e.g., balloons) to gain a volume which generates a positive buoyancy force or to intake gasses which generates a negative buoyancy force as discussed below in connection with FIG. 11.

FIG. 11 is a flowchart of a method 1100 for buoyancy control of an underwater device (e.g., underwater device 100) in accordance with an embodiment of the present disclosure.

Referring to FIG. 11, in conjunction with FIGS. 1-10, in step 1101, control system 101 receives an estimate of the current depth of underwater device 100. In one embodiment, control system 101 receives such an estimate from pressure sensor 102.

As discussed above, pressure sensor 102 is configured to estimate a current depth of underwater device 100. Pressure sensor 102 may correspond to a CTD (conductivity, temperature, depth) sensor, such as, but not limited to, RBRlegato³, SBE 49 FastCAT, etc.

In step 1102, control system 101 calculates the difference between the estimated current depth of underwater device 100 and a target depth, which may be user-designated.

In step 1103, control system 101 determines if the difference between the estimated current depth of underwater device 100 and the target depth exceeds a positive threshold value, which may be user-designated.

In one embodiment, the positive threshold value indicates that there is a need for a positive buoyancy, such as the case when the estimated current depth is below a target depth. By implementing a positive buoyancy, underwater device 100 will be lifted upwards towards the target depth.

If the difference between the estimated current depth of underwater device 100 and the target depth exceeds the positive threshold value, then, in step 1104, control system 101 generates input to motor(s) 106 to generate an upward thrust force (e.g., thrust force 502) based on the difference. For example, the greater the difference, the greater the upward thrust force is generated. By implementing an upward thrust force, underwater device 100 will be lifted upwards towards the target depth.

As stated above, the current depth 501 of underwater device which comes from pressure sensor 102 will be the input of the control loop, and the difference between this value and the target depth is the error, e. The output of the control loop is voltage input to motors 106, which is directly proportional to the speed of motors 106, and the speed of motors 106 is directly proportional to thrust force 502.

In step 1105, control system 101 generates input to fuel cells 104 to produce a net gas rate (e.g., net gas rate 503) which is accumulated by the flexible membranes (e.g., balloons 105) to gain volume which generates a buoyancy force (e.g., buoyancy force 504), such as a positive buoyancy force. In one embodiment, step 1105 is implemented concurrently with step 1104. In one embodiment, the net gas rate (e.g., net gas rate 503) is based on the difference between the estimated current depth of underwater device 100 and the target depth. For example, the greater the difference, the greater the net gas rate.

As discussed above, the depth error rate, e, is also fed to PDA controller 201 to generate a voltage applied to BCD 103 which produces a net gas rate 503 (K/S). Net gas rate 503 is then accumulated by the flexible membranes (e.g., balloons 105) to gain a volume which generate a buoyancy force 504 (e.g., positive buoyancy force). By implementing a positive buoyancy, underwater device 100 will be lifted upwards towards the target depth.

In step 1106, control system 101 determines if underwater device 100 reached its target depth.

If underwater device 100 has not reached its target depth, then, in step 1107, control system 101 receives a new estimate of the current depth of underwater device 100. In one embodiment, control system 101 receives such an estimate from pressure sensor 102.

In step 1108, control system 101 calculates the difference between the newly calculated estimate of the current depth of underwater device 100 and the target depth, which may be user-designated.

Following the new calculation of the difference between the newly calculated estimate of the current depth of underwater device 100 and the target depth, control system 101 generates input to motor(s) 106 to generate an upward thrust force based on such a calculated difference in step 1104.

If, however, underwater device 100 has reached its target depth, then, in step 1109, control system 101 ceases input to fuel cells 104 and motor(s) 106 since underwater device 100 has achieved neutral buoyancy at the target depth.

Returning to step 1103, if the difference between the estimated current depth of underwater device 100 and the target depth does not exceed a positive threshold value, which may be user-designated, then, in step 1110, control system 101 determines if the difference between the estimated current depth of underwater device 100 and the target depth exceeds a negative threshold value, which may be user-designated.

In one embodiment, the negative threshold value indicates that there is a need for a negative buoyancy, such as the case when the estimated current depth is above a target depth. By implementing a negative buoyancy, underwater device 100 will be lowered towards the target depth.

If the difference between the estimated current depth of underwater device 100 and the target depth exceeds the negative threshold value, then, in step 1111, control system 101 generates input to motor(s) 106 to generate a downward thrust force based on the difference. For example, the greater the difference, the greater the downward thrust force is generated. By implementing a downward thrust force, underwater device 100 will be lowered towards the target depth.

As stated above, the current depth 501 of underwater device 100 which comes from pressure sensor 102 will be the input of the control loop, and the difference between this value and the target depth is the error, e. The output of the control loop is voltage input to motors 106, which is directly proportional to the speed of motors 106, and the speed of motors 106 is directly proportional to thrust force 502.

In step 1112, control system 101 generates input to fuel cells 104 to intake gasses, such as the hydrogen and oxygen gasses inside the flexible membranes (e.g., balloons 401, 402, respectively), and convert them to electricity and water thereby generating a negative buoyancy force. By implementing a negative buoyancy force, underwater device 100 will be lowered towards the target depth. In one embodiment, the amount of gasses to intake is based on the difference between the estimated current depth of underwater device 100 and the target depth. For example, the greater the difference, the greater the intake of gasses.

As discussed above, fuel cells 104 are instructed to enter fuel cell mode in which they are able to take gases back and convert them to electricity and water when there is a need to become negative buoyant.

In step 1113, control system 101 determines if underwater device 100 reached its target depth.

If underwater device 100 has not reached its target depth, then, in step 1114, control system 101 receives a new estimate of the current depth of underwater device 100. In one embodiment, control system 101 receives such an estimate from pressure sensor 102.

In step 1115, control system 101 calculates the difference between the newly calculated estimate of the current depth of underwater device 100 and the target depth, which may be user-designated.

Following the new calculation of the difference between the newly calculated estimate of the current depth of underwater device 100 and the target depth, control system 101 generates input to motor(s) 106 to generate a downward thrust force based on such a calculated difference in step 1111.

If, however, underwater device 100 has reached its target depth, then, in step 1116, control system 101 ceases input to fuel cells 104 and motor(s) 106 since underwater device 100 has achieved neutral buoyancy at the target depth.

Returning to step 1110, if, however, the difference between the estimated current depth of underwater device 100 and the target depth does not exceed the negative threshold value, then control system 101 receives another estimate of the current depth of underwater device 100 in step 1101.

As a result of the foregoing, the principles of the present disclosure provide an effective approach for buoyancy control of an underwater device by utilizing both a soft actuator and a hard actuator.

In one embodiment of the present disclosure, a method for buoyancy control of an underwater device comprises receiving an estimate of a current depth of the underwater device. The method further comprises generating an input to fuel cells in the underwater device to produce a net gas rate which is accumulated by the flexible membranes (e.g., balloons) to gain a volume which generates a positive buoyancy force or generating an input to the fuel cells in the underwater device to intake gasses which generates a negative buoyancy force, where the positive buoyancy force and the negative buoyancy force are used to control a depth of the underwater device to reach a target depth from the current depth.

Furthermore, in one embodiment of the present disclosure, the method additionally comprises calculating a difference between the estimated current depth of the underwater device and the target depth.

Additionally, in one embodiment of the present disclosure, the method further comprises generating the input to the fuel cells to produce the net gas rate which is accumulated by the flexible membranes (e.g., balloons) to gain the volume which generates the positive buoyancy force in response the difference exceeding a positive threshold value.

Furthermore, in one embodiment of the present disclosure, the method additionally comprises generating an input to one or more motors to generate an upward thrust force based on the difference between the estimated current depth of the underwater device and the target dept in response to the difference exceeding the positive threshold value.

Additionally, in one embodiment of the present disclosure, the upward thrust force is used to control propellers which controls the depth of the underwater device.

Furthermore, in one embodiment of the present disclosure, the upward thrust force and the positive buoyancy force are used to form a net force which controls a vertical dynamic motion of the underwater device.

Additionally, in one embodiment of the present disclosure, the method further comprises generating the input to the fuel cells to intake gasses which generates the negative buoyancy force in response the difference exceeding a negative threshold value.

Furthermore, in one embodiment of the present disclosure, the method additionally comprises generating an input to one or more motors to generate a downward thrust force based on the difference between the estimated current depth of the underwater device and the target dept in response to the difference exceeding the negative threshold value.

Additionally, in one embodiment of the present disclosure, the downward thrust force is used to control propellers which controls the depth of the underwater device.

Furthermore, in one embodiment of the present disclosure, the downward thrust force and the negative buoyancy force are used to form a net force which controls a vertical dynamic motion of the underwater device.

Additionally, in one embodiment of the present disclosure, the estimate of the current depth of the underwater device is obtained from a pressure sensor.

Furthermore, in one embodiment of the present disclosure, the fuel cells are reversible fuel cells.

Additionally, in one embodiment of the present disclosure, the underwater device corresponds to a service robot.

Other forms of the embodiments of the method described above are in a computer program product and an underwater device.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for buoyancy control of an underwater device, the method comprising;
receiving an estimate of a current depth of said underwater device; and
generating an input to fuel cells in said underwater device to produce a net gas rate which is accumulated by flexible membranes to gain a volume which generates a positive buoyancy force or generating an input to said fuel cells in said underwater device to intake gasses which generates a negative buoyancy force, wherein said positive buoyancy force and said negative buoyancy force are used to control a depth of said underwater device to reach a target depth from said current depth.

2. The method as recited in claim 1 further comprising:
calculating a difference between said estimated current depth of said underwater device and said target depth.

3. The method as recited in claim 2 further comprising:
generating said input to said fuel cells to produce said net gas rate which is accumulated by said flexible membranes to gain said volume which generates said positive buoyancy force in response said difference exceeding a positive threshold value.

4. The method as recited in any one of claim 3 further comprising:
generating an input to one or more motors to generate an upward thrust force based on said difference between said estimated current depth of said underwater device and said target dept in response to said difference exceeding said positive threshold value.

5. The method as recited in claim 4, wherein said upward thrust force is used to control propellers which controls said depth of said underwater device.

6. The method as recited in claim 4, wherein said upward thrust force and said positive buoyancy force are used to form a net force which controls a vertical dynamic motion of said underwater device.

7. The method as recited in claim 2 further comprising:
generating said input to said fuel cells to intake gasses which generates said negative buoyancy force in response said difference exceeding a negative threshold value.

8. The method as recited in any one of claim 7 further comprising:
generating an input to one or more motors to generate a downward thrust force based on said difference between said estimated current depth of said underwater device and said target dept in response to said difference exceeding said negative threshold value.

9. The method as recited in claim 8, wherein said downward thrust force is used to control propellers which controls said depth of said underwater device.

10. The method as recited in claim 8, wherein said downward thrust force and said negative buoyancy force are used to form a net force which controls a vertical dynamic motion of said underwater device.

11. The method as recited in claim 1, wherein said estimate of said current depth of said underwater device is obtained from a pressure sensor.

12. The method as recited in claim 1, wherein said fuel cells are reversible fuel cells.

13. The method as recited in claim 1, wherein said underwater device corresponds to a service robot.

14. An underwater device, comprising;
a control system for controlling said depth of said underwater device using a buoyancy control method comprising:
receiving an estimate of a current depth of said underwater device; and
generating an input to fuel cells in said underwater device to produce a net gas rate which is accumulated by flexible membranes to gain a volume which generates a positive buoyancy force or generating an input to said fuel cells in said underwater device to intake gasses which generates a negative buoyancy force, wherein said positive buoyancy force and said negative buoyancy force are used to control a depth of said underwater device to reach a target depth from said current depth.

15. The underwater device as recited in claim 14, wherein said fuel cells reside within a water tank of said underwater device.

16. The underwater device as recited in claim 14 further comprising:
a robotic manipulator configured to pick, move, or drop a tool.

17. The underwater device as recited in claim 14, wherein said fuel cells correspond to reversible proton exchange membrane fuel cells.

18. A computer program product for buoyancy control of an underwater device, the computer program product comprising one or more computer readable storage mediums having program code embodied therewith, the program code comprising programming instructions for implementing a buoyancy control method comprising:
receiving an estimate of a current depth of said underwater device; and
generating an input to fuel cells in said underwater device to produce a net gas rate which is accumulated by flexible membranes to gain a volume which generates a positive buoyancy force or generating an input to said fuel cells in said underwater device to intake gasses which generates a negative buoyancy force, wherein said positive buoyancy force and said negative buoyancy force are used to control a depth of said underwater device to reach a target depth from said current depth.
